(19) United States
(12) Patent Application Publication
(10) Pub. No.: US 2026/0116220 A1
(43) Pub. Date: Apr. 30, 2026

(54) HIGH VOLTAGE CONTROLLERS INTEGRATED WITH LOW VOLTAGE ZONAL DOMAIN

(71) Applicant: Rivian IP Holdings, LLC, Irvine, CA (US)

(72) Inventors: Sanjeewa Keven SUGATAPALA, Long Beach, CA (US); Muhammad Mobeen MAHMOOD, Carson, CA (US); Chintan SHARMA, Irvine, CA (US); Kyle LOBO, Westchester, CA (US); Vidya RAJAGOPALAN, Palo Alto, CA (US)

(21) Appl. No.: 19/261,826

(22) Filed: Jul. 7, 2025

Related U.S. Application Data
(60) Provisional application No. 63/713,521, filed on Oct. 29, 2024.

(51) Int. Cl. B60L 50/64; B60L 53/80; H01M 50/284

(52) U.S. Cl. CPC B60L 50/64; B60L 53/80; H01M 50/284; H01M 2220/20

(57) ABSTRACT

An integrated power management system for electric vehicles utilizes a centralized power management compartment architecture. The integrated power management system for electric vehicles includes a split high voltage battery pack and redundant integrated power modules. Each integrated power module may combine DCDC power conversion with vehicle load control circuits on a common circuit board.

### CROSS-REFERENCE TO RELATED APPLICATIONS

The present application claims the benefit of U.S. Provisional Application No. 63/713,521, entitled “HIGH VOLTAGE CONTROLLERS INTEGRATED WITH LOW VOLTAGE ZONAL DOMAIN”, filed Oct. 29, 2024, the entirety of which is incorporated herein for reference.

### INTRODUCTION

The present disclosure is directed to power distribution systems in electric vehicles, specifically to integrated power modules.

### SUMMARY

The disclosed subject matter provides for zonal architecture for power distribution and other designs thereof that may allow for integrated power modules that combine direct current to direct current power conversion with vehicle load control circuits.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates an example overhead view of a vehicle with zonal power distribution as described herein.

FIG. 1B illustrates an example side view of a vehicle with zonal power distribution as described herein.

FIG. 1C illustrates an example perspective cross sectional view of a vehicle with zonal power distribution as described herein.

FIG. 2A illustrate an example perspective view associated with the disclosed subject matter.

FIG. 2B illustrates an example block diagram associated with the disclosed subject matter.

FIG. 3 illustrates an example block diagram associated with the disclosed subject matter.

FIG. 4 illustrates an example method associated with the disclosed subject matter.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Conventional electric vehicle power systems often use distributed components, leading to increased complexity, wiring, and reduced reliability. There is a need for more integrated and centralized architectures to improve efficiency, reduce costs, enhance safety, or provide functional redundancy. Systems often struggle with optimal power distribution, safety during charging, or efficient packaging of components. Additionally, architectures may require a 12V or similar low voltage (LV) battery for backup power and system startup, which may add further weight and complexity.

The disclosed subject matter provides for combining high-voltage direct current to direct current (DCDC) power conversion with vehicle load control circuits on common circuit boards. The system may include redundant integrated power modules, each coupled with separate sections of a split high-voltage battery pack. Each integrated power module may include a DCDC converter and various vehicle control circuits which may be on a single circuit board, reducing system complexity while providing fault tolerance through redundancy.

The integration of power conversion and load control functions may minimize numerous wiring harnesses and separate control modules, while enabling removal of the conventional 12V battery. The system may maintain critical functionality during fault conditions through its redundant architecture and isolation capabilities.

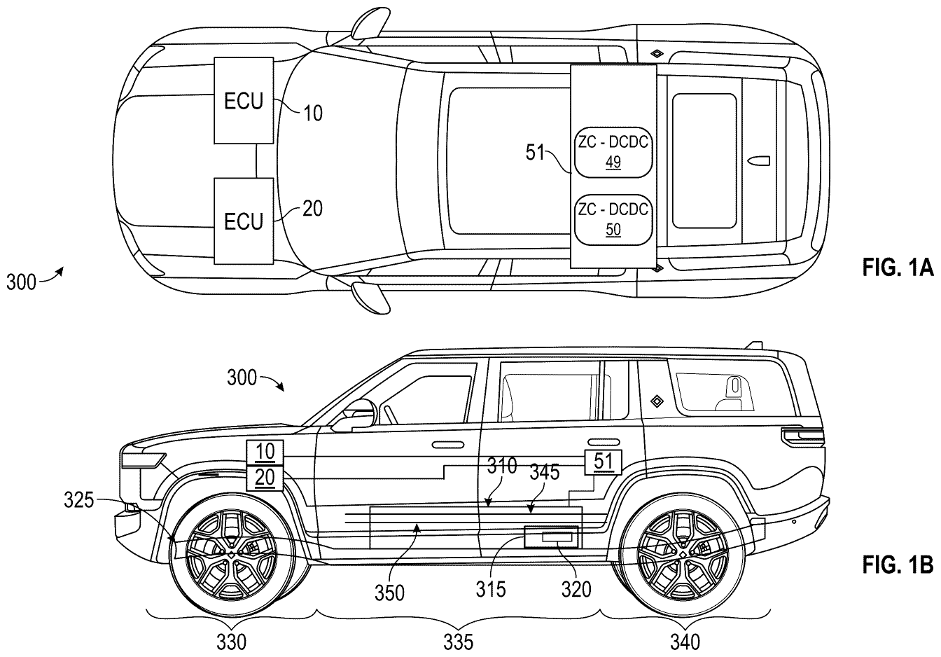

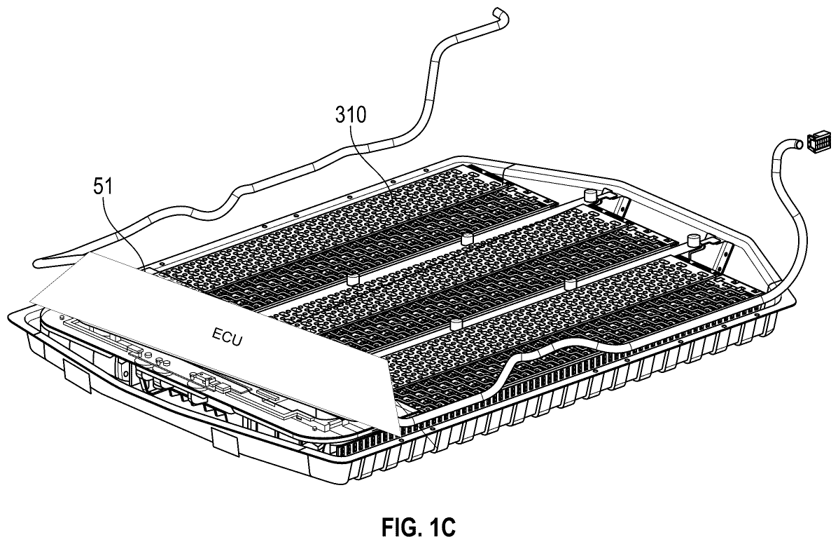

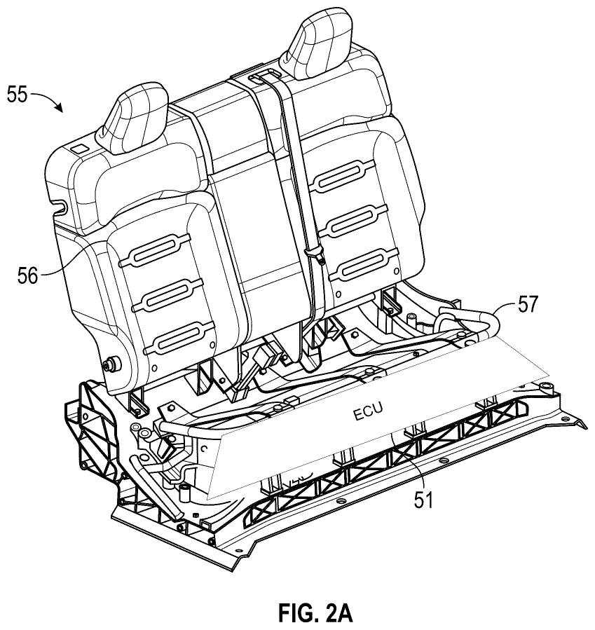

FIG. 1A illustrates an example overhead view of vehicle 300. As further described herein, vehicle 300 may include electronic control units (ECUs) in front portion 330 of vehicle 300 (e.g., ECU 10 and ECU 20), an ECU system in rear portion 340 of vehicle 300 (e.g., ECU 51), which may be a power management compartment, among other things. In an example, ECU 10 may operate components on a first side of a longitudinal axis of vehicle 300, while the ECU 20 may operate components on a second side of the longitudinal axis. The longitudinal axis may be defined as an imaginary line running from the front of vehicle 300 to the rear along its center, dividing vehicle 300 into the first (e.g., left) and second (e.g., right) sides. It is contemplated that a single ECU may be used to operate the functionalities throughout (e.g., left, right, front, or rear) of vehicle 300. ECU 51, which may be referred to rear/south zonal controller—SZC, may operate components at the rear of vehicle 300. ECU 51 may include a direct current to direct current converter module (referred herein as DCDC power electronics module) 49 or DCDC power electronics module 50, as further described herein. DCDC power electronics module 49 (or DCDC power electronics module 50) may be considered a blend of HV DCDC and a zonal controller (e.g., ECU). The DCDC power electronics module 49 is not only a DCDC, but it also may immediately convert HV power and use the converted power for different functions, such as body controls.

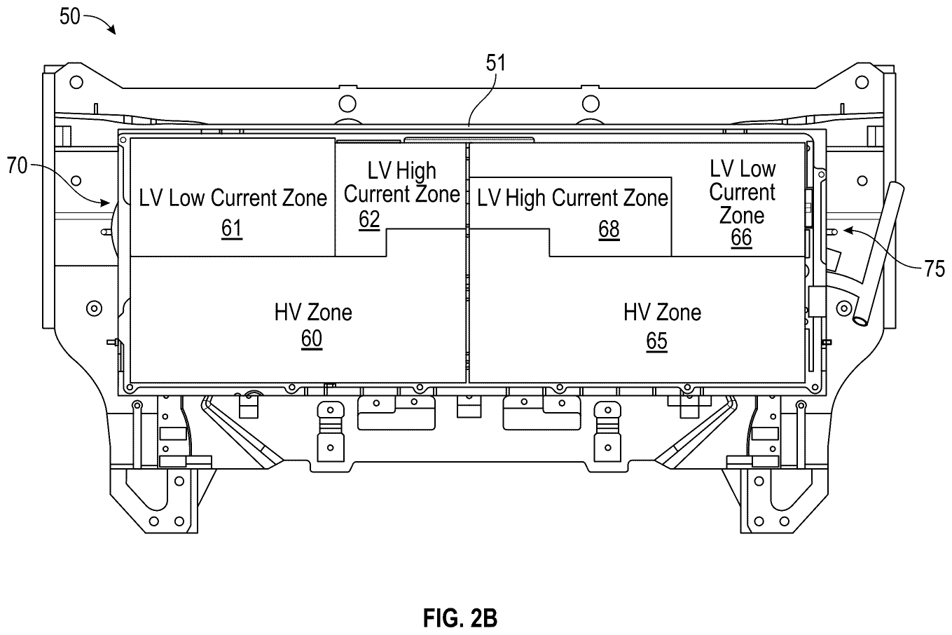

As further described herein, ECU 51 may be a structure that includes power management related components located in a rear of vehicle 300, such as under the second row seat or trunk of vehicle 300. See FIG. 2A. ECU 51 may be the volume of a traditional gas tank and package multiple components as disclosed herein. ECU 51 components may include a left and right DCDC power electronics module (e.g., DCDC power electronics module 49 or DCDC power electronics module 50), or an isolation switch (ISOSW) (e.g., fault isolation system 240), among other things. ECU 51 architecture may provide end-to-end functional redundancy and may enable simplified power management. This approach may allow for more efficient packaging and reduced system complexity.

FIG. 1B illustrates an example side view of vehicle 300. As shown, vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. ECU 10 (also may be referred to herein as east zone controller—EZC 10), ECU 20 (also may be referred to herein as west zone controller—WZC 20), or ECU 51 may be communicatively connected with or have power distributed with each other and may be functionally redundant for power or other operations of electronic components of vehicle 300.

In one or more implementations, vehicle 300 may be an electric vehicle having one or more electric motors that drive wheels 302 of vehicle 300 using electric power from HV battery pack 310. In one or more implementations, vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 300 may be implemented as a truck (e.g., a pickup truck) having a battery pack 310. As shown, HV battery pack 310 may include one or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 1B, vehicle 300 may include a support structure such as chassis 325 (e.g., a frame, internal frame, or other support structure). Chassis 325 may support various components of vehicle 300. As shown, chassis 325 may span front portion 330 (e.g., a hood or bonnet portion), center body portion 335, and rear portion 340 (e.g., a trunk, payload, or boot portion) of vehicle 300 in some implementations. In one or more implementations, HV battery pack 310 may be installed on the chassis 325 (e.g., within one or more of front portions 330, center body portion 335, or rear portion 340). As shown, HV battery pack 310 may include or be electrically coupled with one or more one busbars (e.g., one or more current collector elements). In the example of FIG. 1B, vehicle 300 includes a first busbar 345 and a second busbar 350, either or both of which may include electrically conductive material to connect or otherwise electrically couple battery module(s) 315 or the battery cell(s) 320 with other electrical components of vehicle 300 to provide electrical power to various systems or components of vehicle 300.

FIG. 1C illustrates an example cross-section schematic representation of the power distribution system of vehicle 300. As shown, HV pack 310 may be on a bottom portion of vehicle 300 and ECU 51 may be positioned on top of HV pack 310 and may be connected to one or more components, which may include ECU 10, ECU 20, or body controls among other things.

In other implementations, vehicle 300 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, or any other movable apparatus having battery pack 310 (e.g., that powers the propulsion or drive components of the moveable apparatus).

The disclosed zonal architecture may allow for reduced wiring when compared to other architectures. Shorter wires may provide for less mass and therefore vehicle 300 may weigh less. While wire length generally may not significantly affect cost for small gauge wires, it may influence the overall mass and flexibility of the harness. Longer wires may increase harness bulk, potentially complicating installation due to reduced flexibility.

FIG. 2A illustrates an example perspective cross-sectional view of rear seat assembly 55 of vehicle 300 and ECU 51. ECU 51 may be located under rear seat assembly 55 of vehicle 300, such as under one or more seats 56.

ECU 51 may be rectangular or other shaped structure that houses electrical components such as DCDC power electronics module 49 or DCDC power electronics module 50, or other power management systems. ECU 51, as shown, may be flanked by structural components 57 of rear seat assembly 55 for protecting ECU 51 or support seating elements, such as cushions. Structural components 57 may serve as mounting brackets and structural supports, which may assist with ECU 51 remaining secure during vehicle operation. The assembly may be mounted on the floor pan of vehicle 300. The packaging assembly associated with ECU 51 illustrates the integration of systems beneath passenger areas, optimizing space usage while ensuring easy access for maintenance and upgrades.

FIG. 2B illustrates an example top-down view of the rear assembly 54 which may include ECU 51. ECU 51 may include integrated power module 70 and integrated power module 75 on respective common circuit boards. Integrated power module 70 may primarily supply power to components on the west (e.g., left side) of vehicle 300, while also being available as back-up power for components on the east (e.g., right side) of vehicle 300. Integrated power module 75 may primarily supply power to components on the east (e.g., right side) of vehicle 300, while also being available as back-up power for components on the west (e.g., left side) of vehicle 300. FIG. 2B illustrates an example functional layout of zones that take into consideration voltage or current associated with components. Integrated power module 70 may include High voltage (HV) zone 60, low voltage (LV) low current zone 61, or LV high current zone 62. Integrated power module 70 may include HV zone 65, LV low current zone 66, or LV high current zone 68.

With continued reference to FIG. 2B, HV zone 60 and HV zone 65 may include components or circuitry that may withstand HV (e.g., greater than 60V). LV low current zone 61 and LV low current zone 66 may include components or circuitry that may withstand LV (e.g., between 5V and 16V) and low current. Low current functions may include rear brake lights, turn signals, rear cabin lighting, rear solenoid valves, or second row window motors, which may be below 10 amps. LV high current zone 62 and LV high current zone 68 may include components or circuitry that may withstand LV (e.g., between 5V-16V) and high current. High current function may include trailer tow, park brake, power to downstream zonal controllers, or brake by wire, which may be over 10 amps. The disclosed architecture may have example implementations that include multiple isolation mechanisms for addressing the use of high voltage and low voltage sections as described. These isolation mechanisms may include physical spacing of components or zones, triple-insulated barriers for components or zones, or active monitoring of circuits that detect isolation faults before hazardous conditions develop and trigger an appropriate response. In an example, isolation monitoring circuits may continuously measure impedance between isolated sections with detection thresholds and trigger an appropriate response.

The physical separation and strategic positioning of zones may support the electrical isolation requirements between high voltage and low voltage circuits while enabling the integration of power conversion or control functions within a single enclosed module. This arrangement may address issues with thermal management or electromagnetic interference between sections.

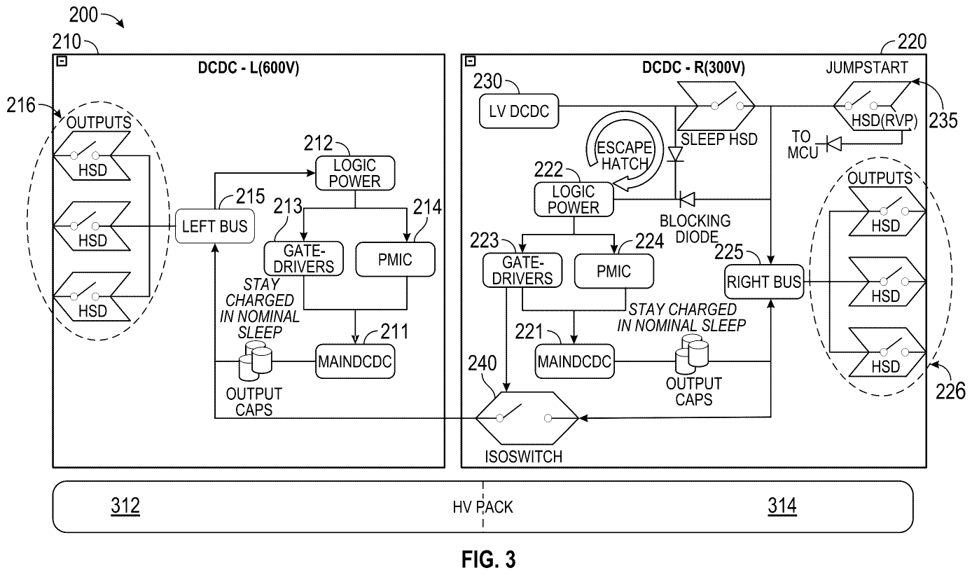

FIG. 3 illustrates an example block diagram of the system disclosed herein. Integrated power distribution system 200 may include HV battery pack 310 that are separated into HV battery section 312 and battery section 314. HV battery section 312 may connected with DCDC power electronics module 210 (e.g., DCDC power electronics module 49) and HV battery section 314 may be connected with DCDC power electronics module 220 (e.g., DCDC power electronics module 50). In an example, the HV battery sections may operate at different voltage levels, such as HV battery section 312 operating at approximately 600V and HV battery section 314 operating at approximately 300V, in which these voltages may vary based on implementation. DCDC power electronics module 210 and DCDC power electronics module 220 are examples of collocating zonal controls, electronic fuses (eFuses), battery management systems (BMS), or other functionality directly on the primary vehicle power source—DCDC, in which the normal vehicle control circuits may combined with the DCDC. For example, body controls, thermal functions, lighting functions, or other functions may be integrated into DCDC power electronics module 210 (e.g., DCDC power electronic module), which may be one (singular) circuit board.

DCDC power electronics module 210 may couple with HV battery section 312 and include main DCDC 211 (e.g., DCDC converter), logic power circuit 212, gate drivers 213, power-management integrated circuit (PMIC) 214, bus 215, or input/outputs (I/O) 216. I/O 216 may include functions of vehicle 300, such as body controls (e.g., windows or cabin lights). DCDC power electronics module 210 may be integrated on a single circuit board and may include one or more functions of vehicle 300 that may traditionally be positioned on a separate circuit board. The one or more functions may include body control circuits for controlling vehicle body components like windows, doors, or seats; thermal control circuits for controlling vehicle heating or cooling systems; lighting control circuits; suspension control circuits; or brake control circuits, among other things. This integration may minimize the need for multiple separate control modules or associated wiring harnesses used in conventional architectures.

Bus 215 may be coupled with multiple high-side driver (HSD) outputs 216. Logic power circuit 212 may receive power from left bus 215 and may provide controlled power to gate drivers 213 and PMIC 214. Gate drivers 213 and PMIC 214 may control operation of main DCDC 211. Output capacitors coupled with main DCDC 211 may maintain charge during normal sleep modes of operation.

Similarly, DCDC power electronics module 220 may couple with HV battery section 312 and include main DCDC 211 (e.g., DCDC converter), logic power circuit 222, gate drivers 223, power-management integrated circuit (PMIC) 224, bus 225, or input/outputs (I/O) 226. I/O 226 may include functions of vehicle 300, such as body controls (e.g., windows or cabin lights). DCDC power electronics module 220 may be integrated on a single circuit board and may include one or more functions of vehicle 300 that may traditionally be positioned on a separate circuit board. The one or more functions may include body control circuits for controlling vehicle body components like windows, doors, or seats; thermal control circuits for controlling vehicle heating or cooling systems; lighting control circuits; suspension control circuits; or brake control circuits, among other things. This integration may minimize the need for multiple separate control modules or associated wiring harnesses used in conventional architectures. DCDC power electronics module 220 may include isolation switch (IsoSwitch) 240, LV DCDC 230, sleep mode related circuitry, or jumpstart related circuitry 235, as further described herein.

Bus 225 may be coupled with multiple HSD outputs 226 and may incorporate additional functionality. LV DCDC 230 may provide backup power capabilities. Logic power circuit 222 may supply controlled power to gate drivers 223 and PMIC 224 for controlling operation of main DCDC 221. DCDC power electronics module 220 may include jumpstart capability through dedicated jumpstart related circuitry 235 and an escape hatch function with blocking diode protection.

Isolation switch 240 may be provided between DCDC power electronics module 210 and DCDC power electronics module 220 to enable electrical and physical isolation. Isolation switch 240 may electrically separate DCDC power electronics module 210 and DCDC power electronics module 220, enabling independent operation when required. Each module may include output capacitors in a charged state during sleep modes, which may ensure availability of power for critical functions. The integration of gate drivers and PMICs with the DCDC conversion circuits may enable coordinated control of power distribution and load switching functions.

The architecture provides redundant power paths while maintaining isolation between high and low voltage sections through the coordinated operation of the main DCDC converters, logic power circuits, and isolation switch. This configuration supports the possible elimination of conventional 12V battery systems while maintaining required system reliability through the dual power module approach.

The integration of power conversion and control circuits onto common circuit boards represents a significant departure from conventional architectures. Each circuit board may incorporate specialized layout techniques and isolation barriers to safely combine high voltage and low voltage circuits. The circuit boards may utilize multi-layer construction with dedicated power planes, signal layers, or isolation regions.

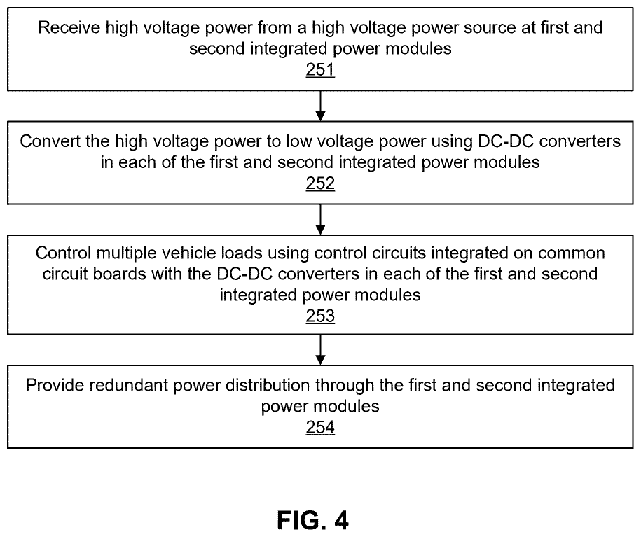

FIG. 4 illustrates an example method 250 for distributing power in a vehicle as disclosed herein. At step 251, high voltage power from a high voltage power source may be received at first and second integrated power modules.

At step 252, the high voltage power may be converted to low voltage power using DCDC converters in each of the first and second integrated power modules. At step 253, multiple vehicle loads may be controlled using control circuits integrated on common circuit boards with the DCDC converters in each of the first and second integrated power modules. At step 254, redundant power distribution through the first and second integrated power modules may be provided.

Additionally, battery systems may be managed using battery management circuits integrated on the common circuit boards. It is also contemplated that overcurrent protection may be provided using electronic fuses integrated on the common circuit boards. Furthermore, vehicle body components may be controlled using body control circuits integrated on the common circuit boards.

The integrated power distribution system 200 described herein may deliver multiple technical affects. By eliminating separate control modules and their associated wiring harnesses, the system may achieve reduced complexity. If its redundant architecture is used, it may enable the removal of the conventional 12V battery, while improving fault tolerance via a split battery pack and redundant integrated power modules. The integrated design may lead to reduced costs and packaging space requirements. Additionally, the co-location of power conversion and control circuits may enable enhanced thermal management capabilities.

Each integrated power module (e.g., DCDC power electronics module 210 or DCDC power electronics module 220) may implement multi-layer fault detection covering voltage levels, currents, temperatures, or communication integrity. Hardware-based protection may respond to severe faults within microseconds, while firmware-based monitoring may handle longer-term fault conditions.

Specific fault handling protocols address different failure scenarios. For battery-related faults, integrated power distribution system 200 may isolate the affected section while maintaining operation through the redundant path. Control circuit faults may trigger failsafe modes that maintain basic vehicle operation with reduced functionality. Communication faults may initiate retry sequences with timeout limits ensuring appropriate system response.

Emergency operation modes may maintain critical vehicle functions when faults occur. If one battery section (e.g., HV battery section 312 or HV battery section 314) or integrated power module (e.g., DCDC power electronics module 210 or DCDC power electronics module 220) fails, integrated power distribution system 200 may automatically reconfigure to supply essential systems through the remaining operational module. Priority-based load shedding may be used to ensure available power delivers to safety-critical systems.

Load current monitoring (e.g., using the electronic fuses) may provide near real-time power consumption data enabling dynamic optimization. Integrated power distribution system 200 may adjust DCDC converter output voltages based on actual load conditions to minimize power losses. Adaptive control algorithms may learn vehicle usage patterns to optimize power distribution and conversion settings.

The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone specific electronic control units (ECUs). The information (e.g., voltage, current, resistance, or proposed functionality), as disclosed herein in the figures and text, is provided for illustrative purposes and other scenarios are contemplated herein.

The term “or” is used inclusively unless otherwise disclosed. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

Methods, systems, or apparatus with regard to vehicle power distribution are disclosed herein. A power distribution system for a vehicle may include a high voltage power source; a first integrated power module coupled with the high voltage power source, the first integrated power module comprising: a first DCDC converter configured to convert high voltage power to low voltage power or a first set of vehicle load control circuits integrated on a common circuit board (e.g., a single circuit board per integrated power module or one for both integrated power modules) with the first DCDC converter; and a second integrated power module coupled with the high voltage power source, the second integrated power module comprising: a second DCDC converter configured to convert high voltage power to low voltage power or a second set of vehicle load control circuits integrated on the common circuit board with the second DCDC converter. The first set of vehicle load control circuits may include body control circuits configured to control vehicle body components, thermal control circuits configured to control vehicle thermal components, or lighting control circuits configured to control vehicle lighting components. The first integrated power module may further include electronic fuses integrated on the common circuit board or a battery management system integrated on the common circuit board. The first or second integrated power modules may provide redundant power distribution paths. All combinations (including the removal or addition of steps) in this paragraph and the above paragraphs are contemplated in a manner that is consistent with the other portions of the detailed description.

An integrated vehicle power module may include a circuit board; a DCDC converter mounted on the circuit board and configured to convert high voltage power to low voltage power; vehicle load control circuits mounted on the circuit board and configured to control multiple vehicle subsystems; a microcontroller mounted on the circuit board and configured to control the DCDC converter and the vehicle load control circuits; and electronic fuses integrated on the circuit board and configured to provide overcurrent protection. The vehicle load control circuits may include window control circuits, seat heater control circuits, door control circuits, suspension control circuits, or brake control circuits. The integrated vehicle power module may further include isolation protection circuits configured to prevent high voltage from reaching low voltage portions of the circuit board. All combinations (including the removal or addition of steps) in this paragraph and the above paragraphs are contemplated in a manner that is consistent with the other portions of the detailed description.

A method of distributing power in a vehicle may include receiving high voltage power from a high voltage power source at first or second integrated power modules; converting the high voltage power to low voltage power using DCDC converters in each of the first or second integrated power modules; controlling multiple vehicle loads using control circuits integrated on common circuit boards with the DCDC converters in each of the first or second integrated power modules; and providing redundant power distribution through the first or second integrated power modules. The method may further include managing battery systems using battery management circuits integrated on the common circuit boards, providing overcurrent protection using electronic fuses integrated on the common circuit boards, controlling vehicle body components using body control circuits integrated on the common circuit boards, controlling vehicle thermal components using thermal control circuits integrated on the common circuit boards, or providing isolation between high voltage portions and low voltage portions of the common circuit boards. All combinations (including the removal or addition of steps) in this paragraph and the above paragraphs are contemplated in a manner that is consistent with the other portions of the detailed description.

What is claimed is:

1. A power distribution system for a vehicle, comprising:
a high voltage battery pack comprising a first battery section and a second battery section;
a first integrated power module coupled with the first battery section, the first integrated power module comprising:
a first direct current to direct current (DCDC) converter configured to convert high voltage power to low voltage power; and
a first set of vehicle load control circuits integrated on a first common circuit board with the first DCDC converter;
a second integrated power module coupled with the second battery section, the second integrated power module comprising:
a second DCDC converter configured to convert high voltage power to low voltage power; and
a second set of vehicle load control circuits integrated on a second common circuit board with the second DCDC converter; and
an isolation switch configured to electrically isolate the first battery section from the second battery section.

2. The power distribution system of claim 1, wherein the first set of vehicle load control circuits comprises body control circuits configured to control first vehicle body components and the second set of vehicle load control circuits comprises body control circuits configured to control second vehicle body components.

3. The power distribution system of claim 1, wherein upon detection of a fault in the first battery section, the isolation switch disconnects the first battery section while maintaining power to critical vehicle systems through the second integrated power module.

4. The power distribution system of claim 1, wherein the first integrated power module further comprises a first battery management system integrated on the first common circuit board for monitoring the first battery section.

5. The power distribution system of claim 4, wherein the second integrated power module further comprises a second battery management system integrated on the second common circuit board for monitoring the second battery section.

6. The power distribution system of claim 1, wherein the first integrated power module and the second integrated power module are on the first common circuit board.

7. The power distribution system of claim 1, further comprising a low voltage DCDC converter coupled with at least one of the first or second battery sections for providing power during vehicle sleep states.

8. An integrated vehicle power module, comprising:
a circuit board;
a DCDC converter mounted on the circuit board and configured to convert high voltage power from a battery section to low voltage power;
vehicle load control circuits mounted on the circuit board and configured to control multiple vehicle subsystems;
a battery management system mounted on the circuit board and configured to monitor the battery section;
a microcontroller mounted on the circuit board and configured to control the DCDC converter and the vehicle load control circuits; and
electronic fuses integrated on the circuit board and configured to provide overcurrent protection.

9. The integrated vehicle power module of claim 8, wherein the battery section comprises approximately one-half of a vehicle high voltage battery pack.

10. The integrated vehicle power module of claim 8, wherein the vehicle load control circuits comprise hazard light control circuits maintained operational during fault conditions.

11. The integrated vehicle power module of claim 8, wherein the vehicle load control circuits comprise a steering circuit, braking control circuits, or circuits for controlling external power input during jump start conditions.

12. The integrated vehicle power module of claim 8, wherein the battery management system monitors cell voltages and temperatures of the battery section.

13. The integrated vehicle power module of claim 8, further comprising power input circuits configured to receive jump start power.

14. The integrated vehicle power module of claim 8, further comprising isolation protection circuits configured to prevent high voltage from reaching low voltage portions of the circuit board.

15. A method of distributing power in a vehicle, comprising:
receiving high voltage power from a high voltage power source at first and second integrated power modules;
converting the high voltage power to low voltage power using DCDC converters in each of the first and second integrated power modules;
controlling multiple vehicle loads using control circuits integrated on common circuit boards with the DCDC converters in each of the first and second integrated power modules; and
providing redundant power distribution through the first and second integrated power modules.

16. The method of claim 15, further comprising managing battery systems using battery management circuits integrated on the common circuit boards.

17. The method of claim 15, further comprising providing overcurrent protection using electronic fuses integrated on the common circuit boards.

18. The method of claim 15, further comprising controlling vehicle body components using body control circuits integrated on the common circuit boards.

19. The method of claim 15, further comprising controlling vehicle thermal components using thermal control circuits integrated on the common circuit boards.

20. The method of claim 15, further comprising providing isolation between high voltage portions and low voltage portions of the common circuit boards.
